(19) United States
(12) Patent Application Publication
(10) Pub. No.: US 2010/0245346 A1
(43) Pub. Date: Sep. 30, 2010

(54) Image Receiving Apparatus and Memory Medium

(75) Inventors: Mikihiro Tanaka, Higashiyamato-shi (JP); Manabu Yano, Hino-shi (JP); Kazuharu Tanaike, Fussa-shi (JP)

Correspondence Address: COHEN, PONTANI, LIEBERMAN & PAVANE LLP, 551 FIFTH AVENUE, SUITE 1210, NEW YORK, NY, 10176, US

(73) Assignee: Casio Hitachi Mobile Communications Co., Ltd., Tokyo (JP)

(21) Appl. No.: 12/710,221

(22) Filed: Feb. 22, 2010

(30) Foreign Application Priority Data
Mar. 31, 2009 (JP) 2009-087639

(51) Int. Cl. G06T 15/00

(52) U.S. Cl. 345/419

(57) ABSTRACT

This invention improves the convenience of viewing three-dimensional image displays. A mobile communications handset can accomplish three-dimensional image displays using image data received by a communications unit and a broadcast reception unit through a display unit provided with a parallax barrier panel. A control unit automatically performs actions to record the image data as an auxiliary recording while the three-dimensional image display is being performed when the three-dimensional image display is performed using the received image data. That is to say, recording of image data relating to the three-dimensional image display is performed automatically in preparation for cases where the display cannot be viewed three-dimensionally due to viewing conditions.

### CROSS-REFERENCE TO RELATED APPLICATION

The present application claims the benefit of Japanese Patent Application 2009-087639, filed Mar. 31, 2009, the entire disclosure of which is incorporated by reference herein.

### FIELD

The present application relates generally to an image receiving apparatus and a memory medium, and more particularly, to an image receiving apparatus and a memory medium suitable for three-dimensional image displays.

### BACKGROUND

In cellular phones and other mobile communication handsets, functionality is progressing in additional functions accompanying image displays, for example television broadcast reception functions. At the same time, various types exist in display device structures. Models using liquid crystal display panels are the mainstream in display devices for mobile communication handsets, and display systems are known which use an electronic parallax barrier (switching liquid crystal panels) to switch between planar and three-dimensional images (for example as disclosed in Unexamined Japanese Patent Application KOKAI Publication No. 2006-121553).

### SUMMARY

However, in the case of three-dimensional images, viewing as a three-dimensional image is impossible if viewing conditions (viewing distance, angle, etc.) are unsuitable, creating the problem of images that are difficult to view. For this reason, when viewing a television program displayed in three dimensions, for example, if the image cannot be viewed correctly as a three-dimensional image, the concern arises that content that the viewer wants to view in detail, such as decisive scenes, for example, could be missed.

The present invention is invented in view of the above problem and the present invention provides an image receiving apparatus that can improve convenience when displaying three-dimensional images, and a memory medium.

The image receiving apparatus according to a first perspective of the present invention is of the type which can accomplish three-dimensional image displays using received image data, and comprises: a determination unit for determining whether to perform a three-dimensional image display using the received image data; and an auxiliary recording unit for recording the received image data as an auxiliary recording at least while a three-dimensional image display is being performed using the image data when the determination unit has determined to perform a three-dimensional image display using the received image data.

The memory medium according to a second perspective of the present invention is characterized by storing, in a computer for controlling an image receiving apparatus that can accomplish three-dimensional image displays using received image data, programs for realizing: a function for determining whether to perform a three-dimensional image display using the received image data; and a function for recording the image data as an auxiliary recording at least while a three-dimensional image display using the image data is being performed when it has been determined to perform a three-dimensional image display using the received image data.

With the present invention, it is possible to improve convenience in three-dimensional image displays.

### BRIEF DESCRIPTION OF THE DRAWINGS

A more complete understanding of the present application can be obtained when the following detailed description is considered in conjunction with the following drawings, in which:

FIG. 1 is a block diagram showing the composition of a mobile communications handset according to an embodiment of the present invention;

FIG. 2A is a drawing used to explain the composition of the display unit shown in FIG. 1 and schematically shows the display unit structure;

FIG. 2B is a drawing used to explain the composition of the display unit shown in FIG. 1 and shows an example of a left-eye image displayed by the display unit;

FIG. 2C is a drawing used to explain the composition of the display unit shown in FIG. 1 and shows an example of a right-eye image displayed by the display unit;

FIG. 2D is a drawing used to explain the composition of the display unit shown in FIG. 1 and shows an example of pixel arrangement in a three-dimensional image;

FIG. 3A is a drawing used to explain a parallax barrier panel and shows an example of a barrier pattern;

FIG. 3B is a drawing used to explain a parallax barrier panel and schematically shows an image transmission mechanism by the barrier pattern;

FIG. 4 is a block diagram showing an example of a function composition realized by the control unit shown in FIG. 1;

FIG. 5A shows an example of information stored in the storage unit shown in FIG. 1 and shows an example of “AUXILIARY RECORDING SETTING INFORMATION”;

FIG. 5B shows an example of information stored in the storage unit shown in FIG. 1 and shows an example of a “RECORDING DATA MANAGEMENT TABLE”;

FIG. 6 is a flowchart explaining the “AUXILIARY RECORDING EXECUTION PROCESS” according to an embodiment of the present invention;

FIG. 7 is a flowchart for explaining a “RECORDING TERMINATION PROCESS” executed by the “AUXILIARY RECORDING EXECUTION PROCESS” shown in FIG. 6; and

FIG. 8 is a flowchart for explaining an “AUXILIARY RECORDING NOTIFICATION PROCESS” executed by the “AUXILIARY RECORDING EXECUTION PROCESS” shown in FIG. 6.

### DETAILED DESCRIPTION

The preferred embodiment of the present invention is described hereafter with reference to the drawings.

This embodiment is described taking as an example the case where the image receiving apparatus according to the present invention is realized as a mobile communication handset such as a cell phone, for example.

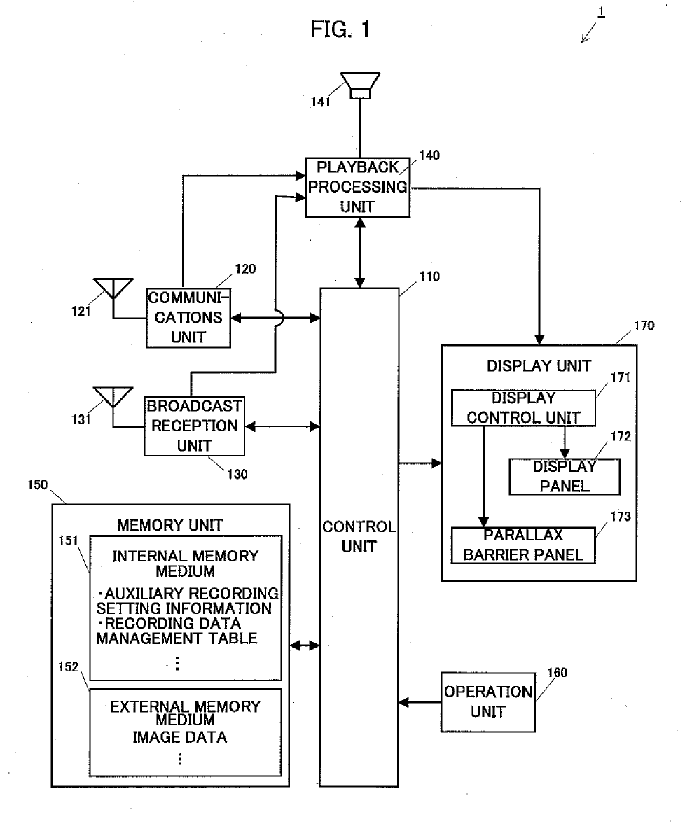

The composition of this type of mobile communications handset 1 is described with reference to FIG. 1. FIG. 1 is a block diagram showing the composition of the mobile communications handset 1.

As shown in the figure, the mobile communications handset 1 is composed of a control unit 110, a communications unit 120, a broadcast reception unit 130, a playback processing unit 140, a memory unit 150, an operation unit 160 and a display unit 170.

The control unit 110 may be composed of, for example, a CPU (central processing unit) and RAM (random access memory) that is the work area, and controls the various parts of the mobile communications handset 1 by executing certain operation programs. That is to say, the various constituent elements of the mobile communications handset 1 are controlled by the control unit 110 and the transfer of information among the various constituent elements is accomplished via the control unit 110.

The communications unit 120 is a constituent element for wireless access when the mobile communications handset 1 is accomplishing communications, and for example may be composed of communications systems using a CDMA (code division multiple access) format or GSM (global systems for mobile communications) format or the like. The communications unit 120 accomplishes wireless sending and receiving through an antenna 121 compatible with those communication formats, and wirelessly communicates with nearby base stations.

Through the action of the communications unit 120, communication actions such as voice communication and data communication are realized. In this embodiment, image data is received via a communications network such as the Internet, for example, through data communications realized by the communications unit 120. That is to say, streaming video content or the like is received via the Internet through the action of the communications unit 120.

The broadcast reception unit 130 is composed of, for example, a tuner module for digital television broadcasts such as One Segment broadcasts, and demodulation of broadcast waves received and station selection are accomplished through an antenna 131 for digital broadcasts. That is to say, reception of broadcast video content (television programs) and the like is achieved through the action of the broadcast reception unit 130.

The playback processing unit 140 is composed of, for example, a decryption circuit that decodes image data (video data (moving image data)) in accordance with the various encryption formats for video images and audio, and accomplishes playback output of video images and audio by decoding image data (video data) received through the communications unit 120 and the broadcast reception unit 130.

That is to say, the playback processing unit 140 accomplishes display output (playback) of video images by outputting to the display unit 170 image signals obtained through decoding the image data (video data). In addition, audio sound output (playback) corresponding to the received video content is accomplished by outputting from a speaker 141 audio signals obtained through decoding audio data contained in the video data.

With this embodiment, it is possible to accomplish three-dimensional image displays (hereafter referred to as “3D displays”) in addition to normal image displays (hereafter referred to as “2D displays”), which are planar image displays, through the composition of the display unit 170 (described in detailed below). With this embodiment, a 3D display function is realized by causing left-eye images to be viewed by the user's left eye and right-eye images to be viewed by the user's right eye through a parallax barrier comprising the display unit 170.

In this case, there are instances when image data compatible with this kind of 3D display format are received by the communications unit 120 and the broadcast reception unit 130. That is to say, image data (video data) composed of left-eye images and right-eye images created in advance are broadcast or streamed. When such image data (video data) is received, the playback processing unit 140 outputs to the display unit 170 image signals created through decoding such.

The memory unit 150 is composed of a memory device such as flash memory, for example, and in addition to storing various data necessary for realizing the present invention and operation programs that the control unit 110 executes, also stores data acquired and created through various processes of the mobile communications handset 1. The memory unit 150 according to this embodiment includes an internal memory medium 151 and an external memory medium 152.

The internal memory medium 151 is composed of flash memory or the like mounted inside the mobile communications handset 1, and primarily stores operation programs executed by the control unit 110 and various data (for example, various parameters and arithmetic formulas) necessary for realizing the present invention.

The external memory medium 152 is composed of a memory card or the like that is removable from the mobile communications handset 1, and primarily stores data acquired or created by the various processes of the mobile communications handset 1. Storing of data on the external memory medium 152 is accomplished primarily through optional actions by the user.

The operation unit 160 is composed of, for example, buttons and keys formed on the outside surface of the casing and is operated by the user of the mobile communications handset 1. The operation unit 160 is provided with input circuits connected to the various buttons and keys, creates input signals in accordance with the user's operation and inputs such to the control unit 110.

With this embodiment, a button for converting the display of video received by the communications unit 120 or the broadcast reception unit 130 into a 2D display or a 3D display through the user's optional actions (hereafter called a display switching button) is included in the operation unit 160. In this case, when a 2D display is being displayed, the display is switched to a 3D display by operating the display switching button, and when a 3D display is being made, the display is switched to a 2D display by operating the display switching button.

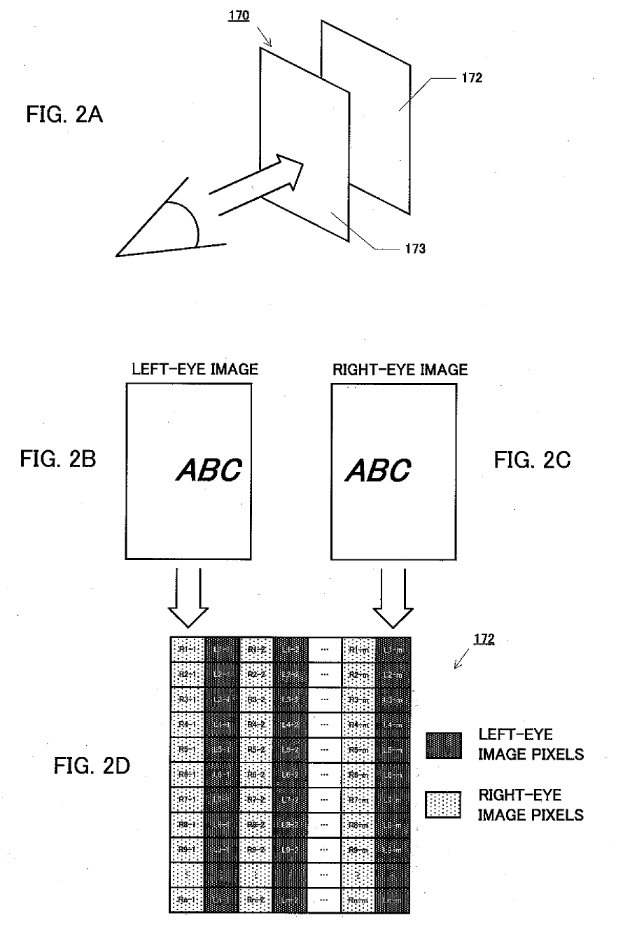

The display unit 170 is a display device composed of a liquid crystal display device, for example, and displays images through control from the control unit 110. The display unit 170 according to the present embodiment is a display device capable of 3D displays. The composition of such a display unit 170 capable of 3D displays is described with reference to FIG. 1 and FIGS. 2A-2D.

The display unit 170 according to the present embodiment realizes 3D displays by being composed of a display control unit 171, a display panel 172 and a parallax barrier panel 173, as shown in FIG. 1.

The display control unit 171 drives and controls the display panel 172 on the basis of image signals from the playback processing unit 140. In addition, it is composed of a driving circuit for driving and controlling the parallax barrier panel 173 when accomplishing 3D displays and a conversion circuit for converting to image signals for 3D displays when the image signals from the playback processing unit 140 are not for 3D displays, and controls display output actions of video received by the communications unit 120 and the broadcast reception unit 130.

The conversion circuit of the display control unit 171 undertakes actions based on existing video conversion technology, such as that disclosed in Unexamined Japanese Patent Application KOKAI Publication No. 2006-121553. Through this, when received video data is not for 3D displays (hereafter called “2D data”), image signals from the playback processing unit 140 are converted into left-eye and right-eye image signals necessary for 3D displays according to the present embodiment.

The display panel 172 is composed of a liquid crystal display panel or the like and displays the display images.

The parallax barrier panel 173 has the same composition as the liquid crystal display panel and controls the transmission direction of light generated by the image display in the display panel 172. To this end, the parallax barrier panel 173 is formed in the display unit 170 so as to be positioned between the display panel 172 and the person viewing the display screen of the display panel 172 (“observer”: the user of the mobile communications handset 1, etc.), as shown in FIG. 2A.

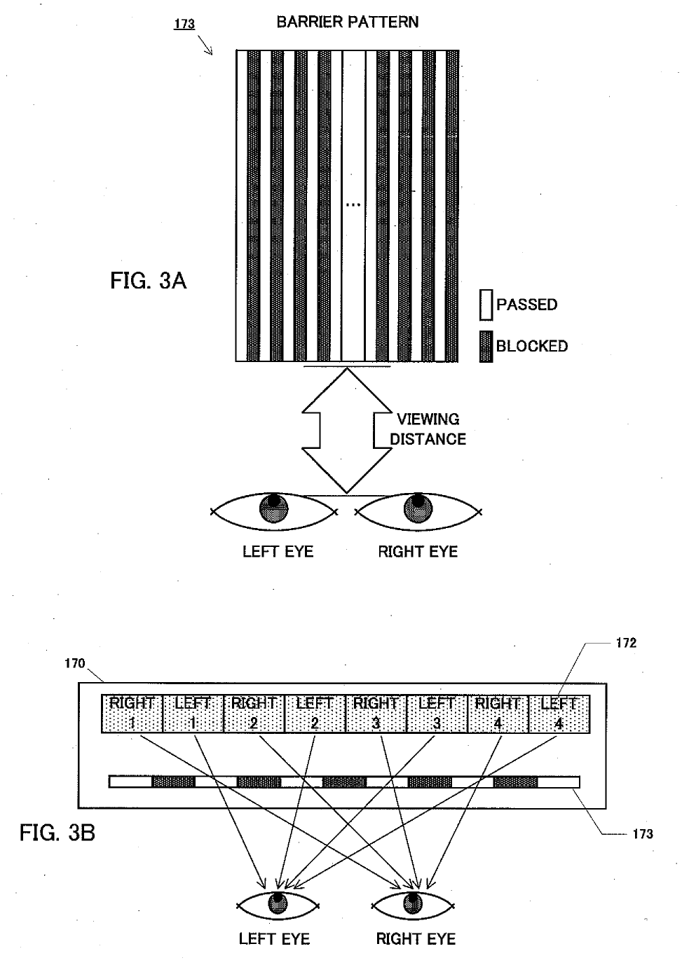

The action principles for accomplishing 3D displays using the display panel 170 having this kind of composition is described with reference to FIGS. 2B-2D and FIGS. 3A-3B.

When a 3D display is made using the parallax barrier panel 173, parallax of the left eye and right eye is used. To this end, when making a 3D display using the display unit 170, left-eye images such as that shown in FIG. 2B and right-eye images such as that shown in FIG. 2C are prepared. The left-eye images and the right-eye images both show the same display subject but are shifted in the left-right direction in accordance with parallax. In the present embodiment, image data (video data) composed of this kind of left-eye and right-eye images is used as the 3D display data (3D data).

The display panel 172 of the display unit 170 alternately displays the display positions of pixels comprising the left-eye image and pixels comprising the right-eye image, causing differences in the left-right direction. That is to say, the display panel 172 displays an image with the pixels comprising the right-eye image arrayed in odd columns and pixels comprising the left-eye image arrayed in even columns, as shown in FIG. 2D.

That is to say, the left-eye image and the right-eye image are respectively arrayed in every other line, resulting in a display in which the lines mutually differ between the left-eye image and the right-eye image. The array pattern need not be in line increments, and for example lines may be comprised of a plurality of pixels. In addition, the arrayed pixel units need not be integer values.

Furthermore, the display panel 172 displays an image (hereafter referred to as a “3D image”) in which the left-eye image and right-eye image are arrayed in stripes in this manner. By making it so that the lines comprised of pixels of the left-eye image reach the left eye of the observer and lines comprised of pixels of the right-eye image reach the right eye of the observer, the two images with parallax as shown in FIGS. 2B and 2C are respectively recognized by the eye corresponding to each. As a result, the both images are synthesized in the observer's brain and viewed as a three-dimensional image.

The parallax barrier panel 173 performs the action of displaying the various lines of images in the 3D image in the direction of the eyes respectively corresponding to those lines. As discussed above, the parallax barrier panel 173 has the same composition as the liquid crystal display panel, and hence by controlling the voltage impressed on electrodes corresponding to each pixel, can pass or block light created by the image display of the display panel 172.

That is to say, the striped barrier pattern is formed so as to correspond to the 3D image lines displayed on the display panel 172, as shown in FIG. 3A. Furthermore, the respective left and right pixels displayed on the display panel 172 pass through the pass-through array of the barrier pattern formed on the parallax barrier panel 173 and reach the observer's corresponding left or right eye, as shown in FIG. 3B.

Through this kind of principle, the image displayed on the display panel 172 is viewed by the observer as a three-dimensional display. However, in order to be viewed three-dimensionally, it is necessary for the distance and angle from the observer's eyes to the display unit 170 (hereafter referred to as “viewing conditions”) to be suitable, and when these conditions are not met, the display in some cases may not be viewed as three-dimensional.

The above is the primary composition of the mobile communications handset 1 according to this embodiment. This is the essential composition for realizing the present invention. Other compositions necessary to realize the primary functions and additional functions of the mobile communications handset 1 may be provided as appropriate.

The action of the mobile communications handset 1 having the above composition is described hereafter. As discussed above, in this embodiment video content (television programs and the like) supplied through digital television broadcasts or distribution via the Internet are received by the communications unit 120 or the broadcast reception unit 130 and are output through the display unit 170. The mobile communications handset 1 according to this embodiment has a function for storing (recording) received video content. Such recording (hereafter referred to as “normal recording”) is accomplished by timer reservation or user instruction through operation of the operation unit 160.

In addition, the mobile communications handset 1 according to this embodiment has a 3D display function. As discussed above, viewing conditions must be appropriate in order for the image displayed in 3D to be viewed as three-dimensional. In the case of a mobile communications handset such as that of this embodiment, the user will often view the video content while holding the mobile communications handset 1, making it difficult to keep the viewing conditions (the distance and angle from the observer's eyes to the screen, etc.) constant. For this reason, there is a possibility that there may be parts that cannot be viewed correctly when a television program is displayed in 3D and viewed with the mobile communications handset 1. Hence, when making 3D displays using the mobile communications handset 1 in this embodiment, an auxiliary recording (hereafter referred to as the “auxiliary recording”) separate from the original recording function is automatically made to supplement through playback after the fact if there are parts that cannot be viewed correctly.

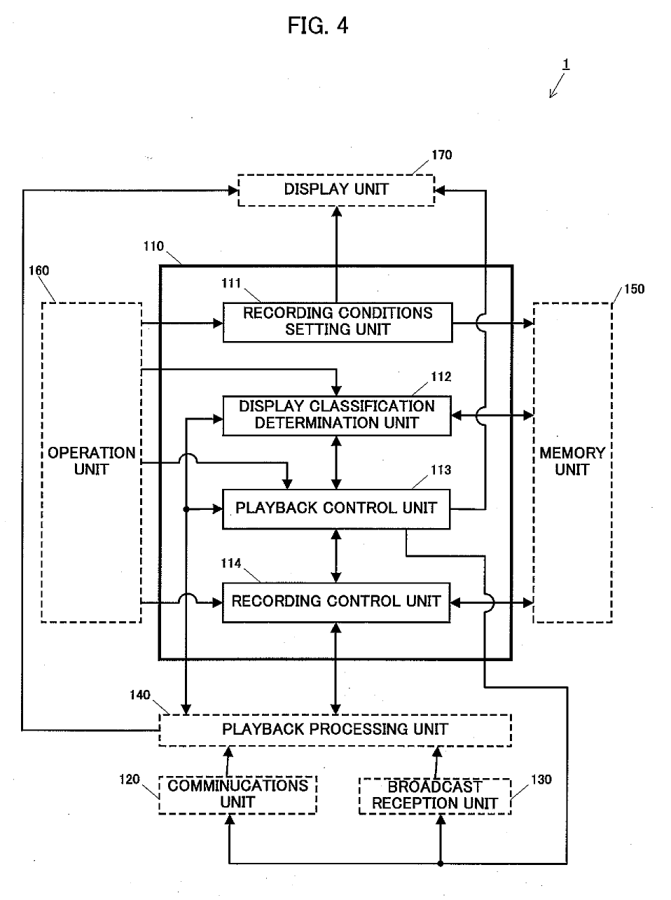

In order to accomplish this action, a function like that shown in FIG. 4 is realized by the control unit 110 executing an operation program stored in the memory unit 150 (internal memory medium 151). As shown in the figure, the control unit 110 functions as a recording conditions setting unit 111, a display classification determination unit 112, a playback control unit 113 and a recording control unit 114.

The recording conditions setting unit 111 sets the conditions for when auxiliary recording is executed and stores setting information showing the setting contents (auxiliary recording setting information) in the memory unit 150. These conditions may be arbitrarily set by the user of the mobile communications handset 1. The setting action in this case may be an action that displays a setting screen automatically when video content is first received by the mobile communications handset 1, or an action that displays the setting screen through willful operation by the user and sets the user's desired conditions.

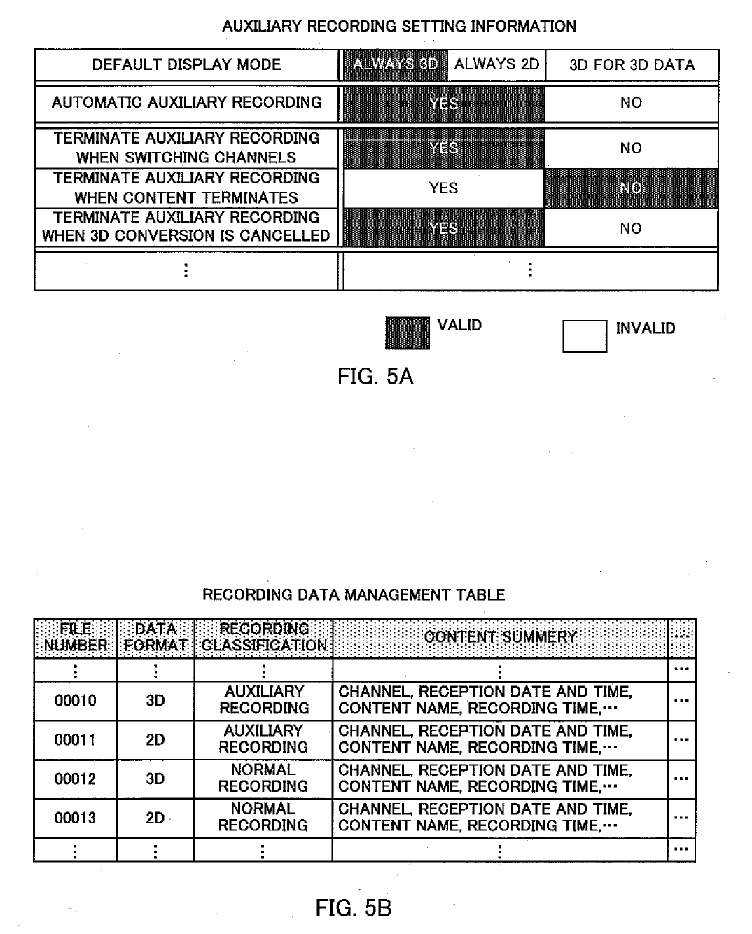

An example of the auxiliary recording setting information recorded in the memory unit 150 is shown in FIG. 5A. In this embodiment, “DEFAULT DISPLAY MODE”, “AUTOMATIC AUXILIARY RECORDING”, “TERMINATE AUXILIARY RECORDING WHEN SWITCHING CHANNELS”, “TERMINATE AUXILIARY RECORDING WHEN CONTENT TERMINATES”, “TERMINATE AUXILIARY RECORDING WHEN 3D CONVERSION IS CANCELLED”, etc. are prepared for example as items comprising the auxiliary recording setting information, and whether the action is on or not (“VALID” or “INVALID”) is recorded for each item.

The item “DEFAULT DISPLAY MODE” indicates the default display mode when video content is received, and as selection options is prepared with, for example, “ALWAYS 3D”, “ALWAYS 2D”, “3D FOR 3D DATA”, etc. The “ALWAYS 3D” mode indicates the action of making a 3D display even when the video data received is 2D data, the “ALWAYS 2D” mode indicates the action of making a 2D display even when the video data received is 3D data and the “3D FOR 3D DATA” mode indicates making a 3D display when the video data received is 3D data and making a 2D display in the case of 2D data. From these choices, the action the user desires is set as “VALID.”

The item “AUTOMATIC AUXILIARY RECORDING” is an item that sets whether auxiliary recording is automatically executed when making a 3D display of video content. When the option “YES” is set to “VALID”, auxiliary recording is automatically started when a 3D display is made, and when the option “NO” is set to “VALID”, auxiliary recording is not executed even when making a 3D display.

The item “TERMINATE AUXILIARY RECORDING WHEN SWITCHING CHANNELS” is one condition for terminating auxiliary recording and is an item indicating whether to terminate auxiliary recording that has been conducted to that point when the reception channel is changed when video content is displayed in 3D through broadcast reception by the action of the broadcast reception unit 130. When the option “YES” is set to “VALID”, auxiliary recording automatically terminates when the reception channel is changed, and when the option “NO” is set to “VALID”, auxiliary recording does not terminate even when the reception change is changed.

The item “TERMINATE AUXILIARY RECORDING WHEN CONTENT TERMINATES” is one condition for terminating auxiliary recording and is an item indicating, when making a 3D display of received video content, whether to terminate auxiliary recording that has been conducted to that point when the content terminates. When the option “YES” is set as “VALID”, auxiliary recording automatically terminates when the content terminates, and when the option “NO” is set to “VALID”, auxiliary recording does not terminate even when the content terminates.

The item “TERMINATE AUXILIARY RECORDING WHEN 3D CONVERSION IS CANCELLED” is one condition for terminating auxiliary recording and is an item indicating, when making a 3D display of received video content, whether to terminate auxiliary recording that has been conducted to that point when the switch is made to 2D display through operation of the display switching button. When the option “YES” is set to “VALID”, auxiliary recording automatically terminates when the switch to 2D display is made, and when the option “NO” is set to “VALID”, auxiliary recording does not terminate even when the switch is made to 2D display.

Description of the functions of the control unit 110 will be continued, returning to FIG. 4.

The display classification determination unit 112 determines whether the received video data is 3D data or 2D data, and whether to make a 3D display or a 2D display of the received video data received, on the basis of the display conditions set by the auxiliary recording setting information.

The playback control unit 113 controls the playback processing unit 140 and the display unit 170, and causes playback of the received video data based on the display classification (3D or 2D) determined by the display classification determination unit 112.

The recording control unit 114 executes normal recording through the user's instructions and also executes auxiliary recording on the basis of the contents of the auxiliary recording setting information when playback by the playback control unit 113 is a 3D display. The recording action here acquires the received video data from the playback processing unit 140 and stores this in the memory unit 150. The recording control unit 114 creates in the memory unit 150 a “RECORDING DATA MANAGEMENT TABLE” in order to manage the video data (recording data) stored in the memory unit 150. An example of this “RECORDING DATA MANAGEMENT TABLE” is shown in FIG. 5B.

As shown in this figure, the “RECORDING DATA MANAGEMENT TABLE” is composed of records keyed on file numbers uniquely attached to each recording data item. Recorded in each record is information indicating whether the video data is 3D data or 2D data (“DATA FORMAT”); information indicating whether this is through normal recording or auxiliary recording (“RECORDING CLASSIFICATION”); the channel on which the content was received and the reception date and time, content name, recording time and so forth (“CONTENT SUMMARY”).

In this embodiment, by recording the “RECORDING CLASSIFICATION” in the “RECORDING DATA MANAGEMENT TABLE”, it becomes possible to identify whether video data that is the real data of the recording data was recorded through normal recording or auxiliary recording. That is to say, by creating the “RECORDING DATA MANAGEMENT TABLE,” it is possible to accomplish a clear distinction through recording classification even if recording data made through normal recording and recording data made through auxiliary recording are stored in the same memory region.

The method of distinguishably storing the recording data made through normal recording and the recording data made through auxiliary recording is arbitrary. For example, the recording data made through normal recording and the recording data made through auxiliary recording may be stored in different folders. Alternatively, the recording data made through normal recording may be stored in the external memory medium 152 while the recording data made through auxiliary recording may be stored in the internal memory medium 151. When the memory areas where these are stored differ in this manner, the above-described “RECORDING DATA MANAGEMENT TABLE” does not necessarily need to be created.

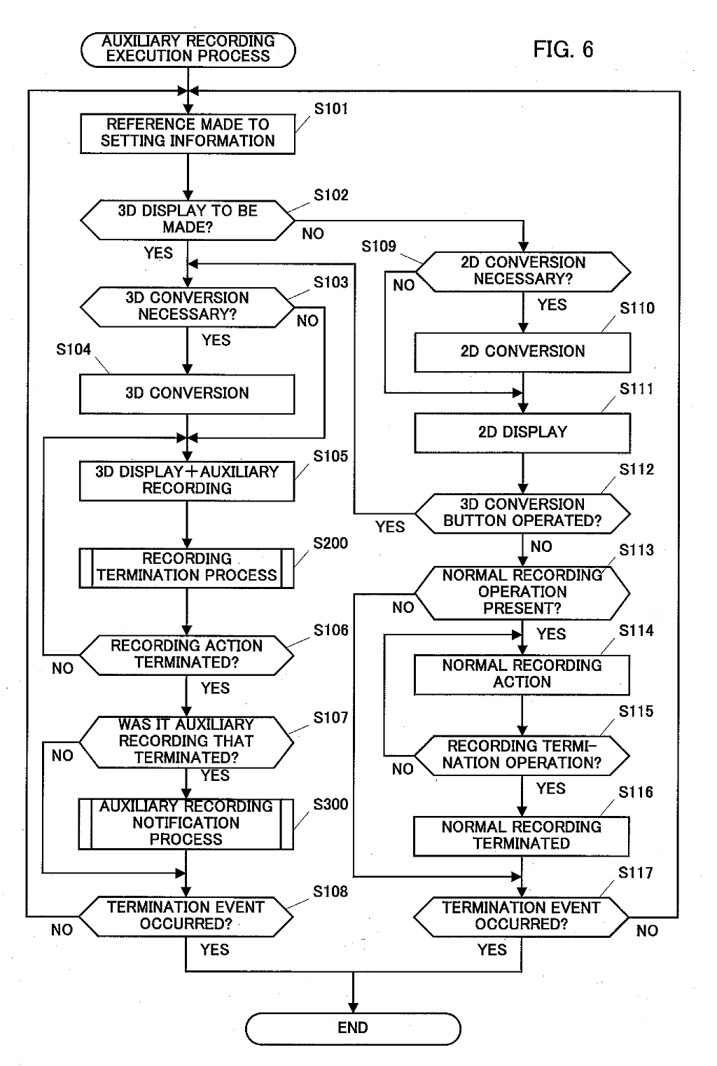

The processes executed through the above functional composition are described hereafter. An “AUXILIARY RECORDING EXECUTION PROCESS” executed when video content is received by the mobile communications handset 1 having the above-described composition is described with reference to the flowchart shown in FIG. 6. This “AUXILIARY RECORDING EXECUTION PROCESS” is started when video content is received by the communications unit 120 or the broadcast reception unit 130 if in the item “AUTOMATIC AUXILIARY RECORDING” the option “YES” is set to “VALID” in the auxiliary recording setting information (FIG. 5A).

When the process begins, the display classification determination unit 112 refers to the auxiliary recording setting information in the memory unit 150 (step S101), and determines whether playback of the video data should be a 3D display (step S102) on the basis of the setting for the default display mode and the data format (3D or 2D) of the received video data.

In the case of the auxiliary recording setting information shown as an example in FIG. 5A, if “ALWAYS 3D” is set to “VALID”, the determination is for a 3D display regardless of whether the received video data is 3D or 2D (step S102: YES). In addition, if “3D FOR 3D DATA” is set to “VALID”, the determination is for a 3D display only when the received video data is 3D (step S102: YES).

On the other hand, when “ALWAYS 2D” is set to “VALID”, or when “3D FOR 3D DATA” is set to “VALID”, the determination is that a 3D display should not be made (a 2D display should be made) when the received video data is 2D (step S102: NO).

The display classification determination unit 112 notifies the playback control unit 113 of the determination contents in step S102. When the determination here is that a 3D display should be made (step S102: YES), the playback control unit 113 determines whether 3D conversion is necessary on the basis of whether the data format of the received video data is 3D or 2D (step S103). That is to say, when the received video data is 2D, the determination is that 3D conversion is necessary in order to accomplish a 3D display (step S103: YES).

When the determination is that 3D conversion is necessary (step S103: YES), the playback control unit 113 instructs the display control unit 171 of the display unit 170 to execute 3D conversion and instructs the playback processing unit 140 to playback the received video data. Through this, the playback processing unit 140 decodes the received video data, and the decoded image signal is sent to the display control unit 171 of the display unit 170. In this case, the display control unit 171 accomplishes 3D conversion creating the left eye image and the right eye image (3D images) on the basis of the image signal from the playback processing unit 140 (step S104).

On the other hand, when the received video data is 3D data, the playback control unit 113 determines that 3D conversion is unnecessary (step S103: NO). In this case, the playback control unit 113 sends only playback instructions to the playback processing unit 140. That is to say, when the received video data is 3D data, the left eye image and right eye image (3D images) are already included, so the display control unit 171 of the display unit 170 does not perform the 3D conversion action.

The display control unit 171 accomplishes a 3D display by controlling the display panel 172 and the parallax barrier panel 173 with the image signal indicating the 3D images created through 3D conversion or the 3D images obtained from the received video data (step S105). At the same time, the playback control unit 113 notifies the recording control unit 114 that the 3D display has started. In response to this notification from the playback control unit 113, the recording control unit 114 starts auxiliary recording (step S105). In this case, the recording control unit 114 successively records in the memory unit 150 the video data played back through the 3D display and records various information relating to this video data in the recording data management table.

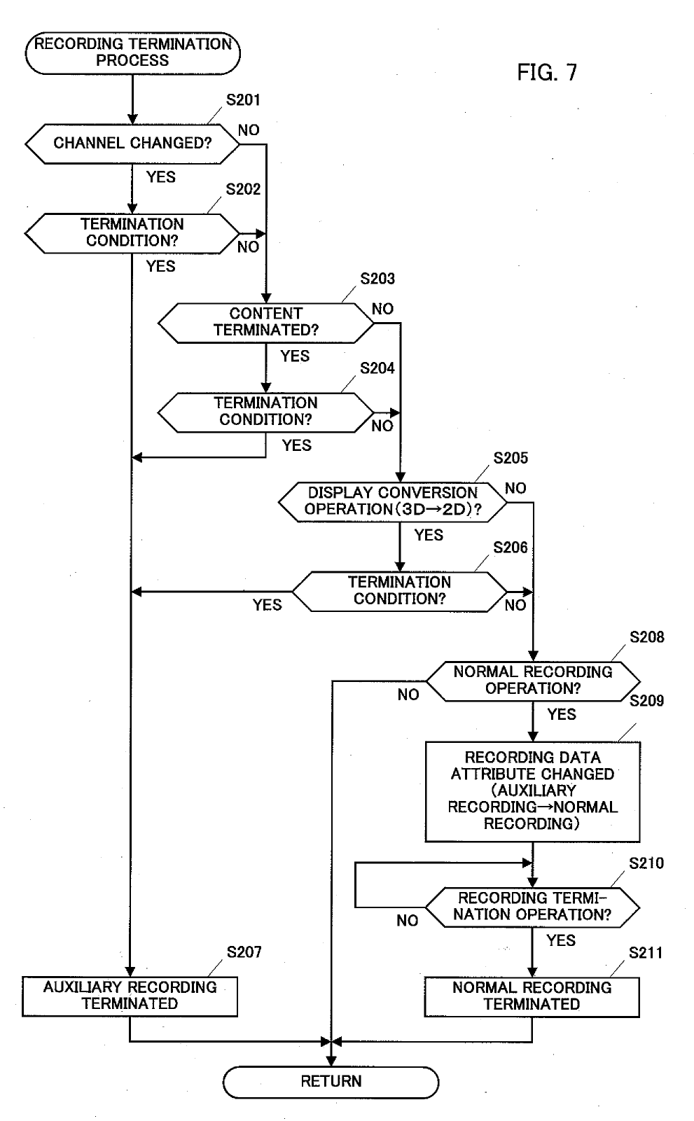

Because auxiliary recording is started automatically when playback through a 3D display is performed in this manner, it is necessary for auxiliary recording to also terminate automatically. Hence, when the auxiliary recording begins, a “RECORDING TERMINATION PROCESS” is executed in order to terminate the recording action (step S200). This “RECORDING TERMINATION PROCESS” is described hereafter with reference to the flowchart shown in FIG. 7.

In this embodiment, auxiliary recording is terminated when an action is performed that matches the termination conditions set by the “AUXILIARY RECORDING SETTING INFORMATION” as an example of which is shown in FIG. 5A. In this case, “TERMINATE AUXILIARY RECORDING WHEN SWITCHING CHANNELS”, “TERMINATE AUXILIARY RECORDING WHEN CONTENT TERMINATES” and “TERMINATE AUXILIARY RECORDING WHEN 3D CONVERSION IS CANCELLED” have been prepared as auxiliary recording terminate conditions, so the recording control unit 114 determines whether an termination condition has been met by detecting the actions indicated in the terminate condition items on the basis of an input signal from the operation unit 160 and the playback action status from the playback control unit 113.

When the user of the mobile communications handset 1 switches the reception channel by operating the operation unit 160 (step S201: YES); the recording control unit 114 refers to the auxiliary recording setting information and determines whether switching the channel is a recording termination condition (step S202).

When it is determined that the content being received has terminated on the basis of the playback action of the playback control unit 113 (step S201: NO; step S203: YES), the recording control unit 114 refers to the auxiliary recording setting information and determines whether terminating of the content is a recording termination condition (step S204).

Alternatively, when the user of the mobile communications handset 1 orders a switch from 3D display to 2D display by operating the display conversion button of the operation unit 160 (step S201: NO; step S203: NO; step S205: YES), the recording control unit 114 refers to the auxiliary recording setting information and determines whether switching to 2D display is a recording termination condition (step S206).

When any of these actions is set as a recording termination condition (step S202: YES; or step S204: YES; or step S206: YES), the recording control unit 114 terminates auxiliary recording (step S207) and the current flow returns to the flow of the “AUXILIARY RECORDING EXECUTION PROCESS” (FIG. 6). That is to say, auxiliary recording automatically started by the 3D display automatically terminates on the basis of preset conditions.

In addition, when these actions are not performed (step S201: NO; step S203: NO; step S205: NO), or when the detected actions are not set as recording termination conditions (step S202: NO; step S204: NO; step S206: NO), the recording control unit 114 determines whether normal recording has been indicated by the user's arbitrary operation (step S208).

That is to say, because auxiliary recording is automatically started, there are times when the user willfully starts recording without being aware of this recording. In this case (step S208: YES), the recording control unit 114 switches the auxiliary recording being performed to normal recording. In this case, the recording control unit 114 converts the attribute information shown in data format in the recording data management table (FIG. 5B) from “AUXILIARY RECORDING” to “NORMAL RECORDING” (step S209).

Because this normal recording is started by instructions from the user, terminating it is not automatic as in the case of auxiliary recording but is performed based on the user's instructions. Hence, the recording action is performed until a recording termination instruction is input by the user operating the operation unit 160 (step S210: NO). Furthermore, in response to a recording termination instruction being input, the recording control unit 114 terminates the recording action of normal recording (step S211) and the current flow returns to the flow of the “AUXILIARY RECORDING EXECUTION PROCESS” (FIG. 6).

When none of the above-described actions occurs (step S201: NO; step S203: NO; step S205: NO; step S208: NO), or when the detected actions are not set as recording termination conditions (step S202: NO; step S204: NO; step S206: NO), the recording control unit 114 dose not terminate any of the recording actions, and the current flow returns to the flow of the “AUXILIARY RECORDING EXECUTION PROCESS” (FIG. 6).

Furthermore, if the recording action is not terminated by the “RECORDING TERMINATION PROCESS” (step S106: NO), the auxiliary recording action continues along with the 3D display and during that time the “RECORDING TERMINATION PROCESS” can be performed at any time (step S105, step S200).

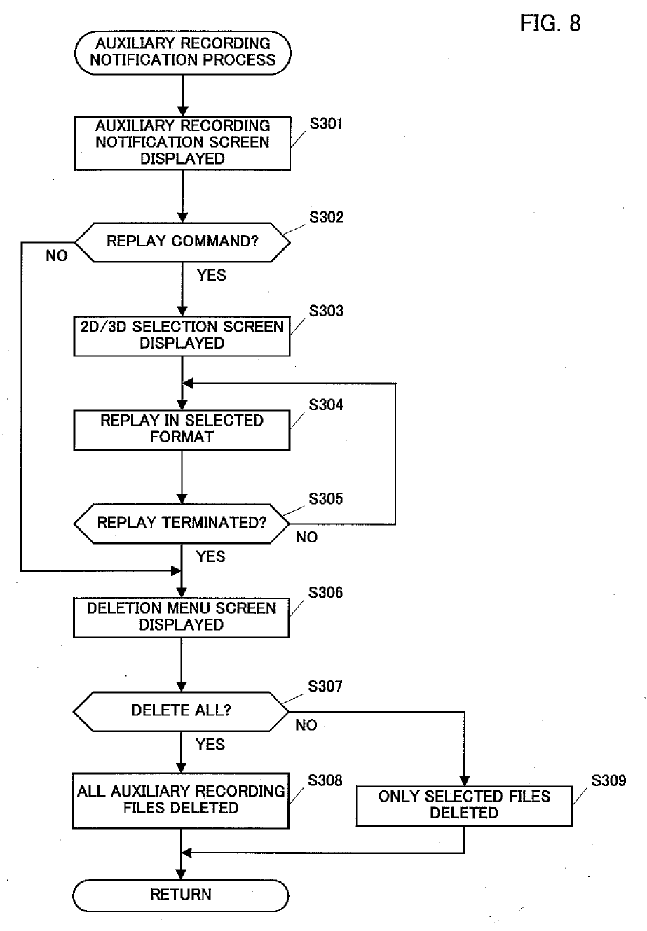

Through the various determinations of the “RECORDING TERMINATION PROCESS” (step S200), actions equating to recording termination conditions are detected, and when auxiliary recording has terminated (FIG. 7, step S207) or normal recording has terminated (FIG. 7, step S211) (step S106: YES), if the terminated recording is auxiliary recording (step S107: YES), the recording control unit 114 notifies the playback control unit 113 that auxiliary recording has terminated. In response to this notification from the recording control unit 114, the playback control unit 113 executes an “AUXILIARY RECORDING NOTIFICATION PROCESS” (step S300). This “AUXILIARY RECORDING NOTIFICATION PROCESS” is described with reference to the flowchart shown in FIG. 8.

When the process begins, the playback control unit 113 displays on the display unit 170 an “AUXILIARY RECORDING NOTIFICATION SCREEN” notifying the user that auxiliary recording was performed (step S301). That is to say, because auxiliary recording is automatically started along with the 3D display, it can be considered that the user may not be aware of this execution, so notification of the recording is made.

On this auxiliary recording notification screen, it is preferable to display the fact that parts where 3D displays were made were recorded and that when the 3D display could not be viewed well, it can be viewed again through replay. Hence, a button for ordering replay of the video for which auxiliary recording was made is displayed along with the auxiliary recording notification screen.

When the user of the mobile communications handset 1 has received notification through the auxiliary recording notification screen and desires replay of the recorded content, a replay instruction is input through the replay button by operating the operation unit 160. In this case, the playback control unit 113 displays on the display unit 170 a selection screen for the user to select whether the display format during replay should be 3D display or 2D display (step S303). The user indicates the desired display format by operating the operation unit 160.

The playback control unit 113 controls the playback processing unit 140 and the display unit 170 and plays, in the designated display format, the video data recorded through auxiliary recording (step S304).

When this playback terminates (step S305: YES), the playback control unit 113 displays on the display unit 170 a “DELETION MENU SCREEN” for designating the method of deleting the video data recorded through auxiliary recording (step S306).

The display of this “DELETION MENU SCREEN” is performed even when playback of the video data recorded through auxiliary recording is not indicated (step S302: NO).

That is to say, because auxiliary recording is prepared for cases when the 3D display cannot be viewed well, if there are no problems in viewing the 3D display, data recorded as the auxiliary recording does not necessarily need to be stored. The same is true when parts that could not be viewed well have been viewed through replay. Furthermore, if the user desires to store that content, normal recording can be performed, so the video data recorded as the auxiliary recording is often not used or only temporarily used. Hence, it is preferable for recording data made through auxiliary recording to be easily erasable so as to not overload the memory region of the memory unit 150.

For this reason, “DELETE ALL” or “DELETE SELECTED” or the like are prepared as deletion methods on the “DELETION MENU SCREEN”, and the user can select the desired deletion method by operating the operation unit 160. In this embodiment, it is possible to perform bulk deletion easily because data recorded through normal recording and data recorded through auxiliary recording are distinguishably recorded, as described above. In the case of this embodiment, the recorded data for which “AUXILIARY RECORDING” is entered as the “RECORDING CLASSIFICATION” in the “RECORDING DATA MANAGEMENT TABLE” may be deleted. In addition, even when deletion is to be performed through the user's selection, the user can select files to be deleted from among the data recorded by auxiliary recording. This is the same for cases when a folder or memory medium is changed between normal recording and auxiliary recording.

If the deletion method selected by the user is “DELETE ALL” (step S307: YES), the playback control unit 113 deletes from the memory unit 150 all of the files (recorded data) recorded by auxiliary recording (step S308), and if the selection is “DELETE SELECTED” (step S307: NO), playback control unit 113 deletes from the memory unit 150 only the files (recorded data) designated by the user (step S309), and then the current flow returns to the flow in the auxiliary recording execution process (FIG. 6).

In the “AUXILIARY RECORDING EXECUTION PROCESS”, the processes from step S101 on are repeatedly performed until the occurrence of a termination event such as the power off of the mobile communications handset 1 or the termination of receiving video content (step S108: NO).

The process when it is determined that the received video content should be played back through a 2D display (step S102: NO) will be explained hereafter.

In this case, the playback control unit 113 determines whether 2D conversion is necessary on the basis of whether the received video data is 3D data or 2D data (step S109). That is to say, when the received video data is 3D data, the determination is that 2D conversion is necessary in order to make a 2D display (step S109: YES).

When it is determined that 2D conversion is necessary (step S109: YES), the playback control unit 113 indicates execution of 2D conversion to the display control unit 171 of the display unit 170 and also indicates playback of the received video data to the playback processing unit 140. Through this, the playback processing unit 140 decodes the received video data, and the decoded image signals are sent to the display control unit 171 of the display unit 170. In this case, the image signals of the left-eye image and the right-eye image (3D image) are input into the display control unit 171 from the playback processing unit 140, so 2D conversion is performed to create a 2D image signal with no parallax (step S110).

When the received video data is 2D data (step S109: NO), it is not necessary to perform this kind of 2D conversion. Hence, a 2D display of received video content is performed by the display control panel 171 controlling the display panel 172 and the parallax barrier panel 173 on the basis of the 2D image signal created by the display control unit 171 or 2D image signals obtained from the received 2D data (step S111).

When a 2D display is made in this manner, if the user operates the display switch button of the operation unit 160 and indicates a switch to 3D display (step S112: YES), a 3D display is made by performing the above-described processes from step S103 on, and auxiliary recording is started (steps S103 through S108).

On the other hand, if no instruction to switch to 3D display is made (step S112: NO), when an operation indicating normal recording is undertaken (step S113: YES), normal recording is executed by the recording control unit 114 (step S114) and the recording action terminates at the same time as a recording termination instruction from the user (step S115: YES; step S116).

When no instruction for normal recording is given (step S113: NO), or if normal recording terminates (step S116), the processes from step S101 on are repeatedly performed until the above-described termination event occurs (step S117: NO), and the process terminates at the same time the termination event occurs (step S117: YES).

As explained above, by applying the present invention as in the above-described embodiment, it is possible to record received images in preparation for cases when viewing such is difficult in real time, when the received images are displayed through three-dimensional image displays (3D displays).

In this case, because the determination of whether the image is a three-dimensional image is made on the basis of information about the received image (program information, etc.), it is possible to swiftly accomplish recording through auxiliary recording.

In addition, even when a planar image display (2D display) is made, auxiliary recording is executed along with the user's switch to a three-dimensional image display (3D display), so it is possible to make a recording with certainty in preparation for cases of images being difficult to view in real time.

In addition, even when the received image data is planar image data (2D data), this data is converted to three-dimensional images, so all content can be viewed as three-dimensional image displays (3D displays) and a recording can be made in preparation for cases when the three-dimensional image display (3D display) is difficult to view.

In addition, auxiliary recording can be automatically terminated under certain conditions, so it is possible to conserve the memory region used by auxiliary recordings that are unused or temporarily used.

In addition, the user is notified of the fact that an auxiliary recording has been made, so it is possible for the user to know that the content they were viewing has been recorded and it is possible to efficiently perform an operation to replay the content when viewing was difficult in real time.

Furthermore, image data recorded through auxiliary recording and image data recorded through normal recording are distinguishably recorded, so it is easy to delete image data made through auxiliary recording that is unused or temporarily used.

In addition, executing and terminating auxiliary recording are accomplished on the basis of information set by the user, so it is possible to accomplish recording operations in accordance with the user's usage mode.

The above-described embodiment is one example, and the range of application of the present invention is not limited thereby. That is to say, various applications are possible, and all embodiments are included within the scope of the present invention.

For example, in the present embodiment the case wherein the image receiving apparatus according to the present invention is realized through a mobile communications handset is illustrated as an example, but this is not limited to a mobile communications handset, for the present invention may be applied to various image receiving apparatuses as long as such is provided with a display unit that enables three-dimensional viewing of images.

In addition, not only by applying to an image receiving apparatus prepared in advance the composition according to the present invention but by applying the program to an existing image receiving apparatus, it is possible for this to function as the image receiving apparatus according to the present invention.

The method of applying the program is arbitrary, for the program can be applied by being stored on a CD-ROM, memory card or other memory medium, or can be applied via communications media such as the Internet, for example.

Having described and illustrated the principles of the present application by reference to one (or more) preferred embodiment(s), it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

What is claimed is:

1. An image receiving apparatus of the type which can accomplish three-dimensional image displays using received image data, comprising:
a determination unit for determining whether to perform a three-dimensional image display using the received image data; and
an auxiliary recording unit for recording the received image data as an auxiliary recording at least while a three-dimensional image display is being performed using the image data when the determination unit has determined to perform a three-dimensional image display using the received image data.

2. The image receiving apparatus according to claim 1, wherein the determination unit determines to perform a three-dimensional image display using the image data when attribute information attached to the received image data indicates that the image data can be three-dimensionally displayed.

3. The image receiving apparatus according to claim 1, further comprising an input unit for inputting instruction signals indicating whether to perform a three-dimensional image display in response to operations by a user;
wherein the determination unit determines whether to perform a three-dimensional image display using the received image data on the basis of the instruction signals from the input unit.

4. The image receiving apparatus according to claim 3, further comprising a conversion unit for converting image data that is not image data for three-dimensional image displays into image data for three-dimensional image displays;
wherein the conversion unit converts the received image data into image data for three-dimensional image displays when the determination unit has determined to perform a three-dimensional image display on the basis of the instruction signals.

5. The image receiving apparatus according to claim 1, wherein the auxiliary recording unit further comprises a terminating unit for terminating the executed auxiliary recording on the basis of predetermined conditions relating to the image data being recorded.

6. The image receiving apparatus according to claim 5, wherein the terminating unit terminates the auxiliary recording when the user switches channels for receiving the image data.

7. The image receiving apparatus according to claim 5, wherein the terminating unit terminates the auxiliary recording when content shown by the received image data terminates.

8. The image receiving apparatus according to claim 1, further comprising a notification unit for notifying the user that image data recorded through auxiliary recording exists when auxiliary recording has been terminated by the auxiliary recording unit.

9. The image receiving apparatus according to claim 1, further comprising a storage-use recording unit for recording the image data as images for storage when recording of the received image data is specified by the user of the image receiving apparatus.

10. The image receiving apparatus according to claim 9, further comprising a memory unit for distinguishably storing image data recorded by the auxiliary recording unit and image data recorded by the storage-use recording unit.

11. The image receiving apparatus according to claim 10, wherein the memory unit stores setting information relating to actions of the auxiliary recording unit; and
the auxiliary recording unit accomplishes actions relating to auxiliary recording on the basis of determination results from the determination unit and the setting information stored by the memory unit.

12. A memory medium for storing, in a computer for controlling an image receiving apparatus that can accomplish three-dimensional image displays using received image data, programs for realizing:
a function for determining whether to perform a three-dimensional image display using the received image data; and
a function for recording the image data as an auxiliary recording at least while a three-dimensional image display using the image data is being performed when it has been determined to perform a three-dimensional image display using the received image data.
